(19) United States
(12) Patent Application Publication
(10) Pub. No.: US 2009/0291680 A1
(43) Pub. Date: Nov. 26, 2009

(54) WIRELESS COMMUNICATION NETWORK AND WIRELESS CONTROL OR MONITORING DEVICE EMPLOYING AN XML SCHEMA

(76) Inventors: Deborah K. Mort, Coraopolis, PA (US); Luis R. Pereira, Milwaukee, WI (US); Sujit R. Das, New Berlin, WI (US); Marco Naeve, Milwaukee, WI (US)

Correspondence Address: Martin J. Moran, 1000 Cherrington Parkway, Moon Township, PA, 15108, US

(21) Appl. No.: 12/126,530

(22) Filed: May 23, 2008

(51) Int. Cl. H04Q 7/20; H04M 1/00

(52) U.S. Cl. 455/422.1; 455/561

(57) ABSTRACT

A wireless communication network includes a plurality of wireless devices and a reconfigurable wireless control or monitoring device structured to wirelessly communicate with the wireless devices. The wireless control or monitoring device includes a wireless transceiver, a user output device, a user input device, and a processor cooperating with the wireless transceiver, the user output device and the user input device. The processor includes a routine structured to output first information from the wireless devices to the user output device, or to input second information from the user input device to the wireless devices. The routine is further structured to employ an XML schema to define the first information output from the wireless devices to the user output device, or to define the second information input from the user input device to the wireless devices.

This invention was made with U.S. Government support under Contract No. DE-FC36-04GO14000 awarded by the Department of Energy. The Government has certain rights in this invention.

### BACKGROUND OF THE INVENTION

1. Field of the Invention

This invention pertains generally to wireless communication and, more particularly, to wireless communication networks including wireless devices, such as sensors and/or actuators. The invention also relates to a wireless control or monitoring device for a wireless communication network such as, for example, a wireless sensor network.

2. Background Information

Removing wires from existing and new products (e.g., industrial; residential; commercial) significantly reduces installation time, simplifies the installation process, and reduces cost.

A monitoring and commissioning tool is needed to aid the installation of such products, and following commissioning, to monitor and control various product parameters. However, it is believed that such a tool would become obsolete relatively fast and need to be redesigned in order to support new wireless products. In addition, when the wireless communication protocol used to monitor the products changes, or when a supported protocol is not available in a particular environment, it is believed that such a tool would not function.

Industrial and commercial wireless sensor networks based on Low-Rate Wireless Personal Area Network (LR-WPAN) technologies are emerging as a powerful enabler of cost-effective, distributed systems. These LR-WPAN technologies are increasingly being deployed in monitoring and control applications.

Evolving industrial protocols tend to exhibit certain properties that make them difficult to interoperate with devices based in more recent technologies, like LR-WPAN. Since concepts like self-discovery and self-configuration are common paradigms in these types of devices, it is a logical step to apply some of these principles to increase the added value of this new generation of products.

At the same time, it is believed that the interoperation and integration of these new solutions into an ongoing industrial environment is a subsequent challenge to be solved. Part of this evolution requires the interaction with legacy, but currently maintained, industrial protocols, such as, for example and without limitation, INCOM (INdustrial COMmunications)

An INCOM network provides two-way communication between an INCOM network master and a variety of devices such as, for example, electrical circuit interrupting devices, circuit breakers, digital meters, motor overload relays, monitoring units and a wide range of industrial and electrical distribution products. Control and monitoring is carried out over a communication network consisting of dedicated twisted pair wires. Preferably, a suitable circuit provides a simple, low-cost interface to the communication network. For example, a Sure Chip Plus™ microcontroller, mixed-mode analog-digital application specific integrated circuit (ASIC) including a microprocessor, enables a control, protection or monitoring device to communicate with the INCOM network. This integrated circuit provides various network functions such as, for example, carrier generation and detection, data modulation/demodulation, address decoding, and generation and checking of a 5-bit cyclic redundant BCH error code. Alternatively, suitable INCOM communicating ASICs may be employed such as, for example, an ASIC intended for use with an external microprocessor. INCOM may employ a wide range of modulation techniques and baud rates (e.g., without limitation, FSK (9600 baud); base band (153.2 Kbaud)). Examples of the INCOM network and protocol are disclosed in U.S. Pat. Nos. 4,644,547; 4,644,566; 4,653,073; 5,315,531; 5,548,523; 5,627,716; 5,815,364; and 6,055,145, which are incorporated by reference herein.

For several reasons, industrial protocols, such as INCOM, offer interesting challenges at the time of integration. First, due to market, historical and/or engineering needs, the protocol definition is continuously evolving and different devices often use disjoint variants or subsets of the protocol.

Second, the development and maintenance costs of networking and commissioning tools gets affected, since they have to contain information about all possible devices, legacy and current, in the field.

These characteristics render inefficient the implementation of devices with a predetermined protocol stack. The construction of a device that takes into account all possibilities or variants of the protocol at design time is simply impractical. Considering that the protocol itself is evolving, and devices implementing yet another variant of the protocol are certain to be implemented in the future, this traditional approach is arguably unsustainable.

As experienced many times, the designers of monitoring and control systems often do not have control over the deployment and configuration of future devices to be monitored and controlled.

The act of modifying an application, or system, as it runs is called dynamic reconfiguration. The usefulness of this act has been demonstrated in many applications, like antivirus programs. To support dynamic reconfiguration, the application or distributed system must have several properties. As a brief summary, relevant properties include: (1) the user must be able to concretely define the reconfigurable attributes of the system; (2) there must exist a method to provide to the system the necessary information for reconfiguration from a source external to the system—and this must be synchronized to avoid deadlocks; and (3) all information characterizing the reconfigurable process must be represented and exercised during the reconfiguration process. Essentially, such dynamic reconfiguration must be able to define a set of attributes that characterizes the behavior to reconfigure, and a process to reconfigure it.

An important consideration to take into account is the set of behaviors or states to which the system can be reconfigured, or in other words, supporting reconfigurability by design. Unbounded support for reconfiguration will ultimately defeat the advantages for implementing dynamic reconfiguration in the first place. Therefore, careful consideration should be taken when choosing the set of reconfigurable behaviors.

Accordingly, there is room for improvement in wireless communication networks.

There is also room for improvement in wireless control or monitoring devices for wireless communication networks.

### SUMMARY OF THE INVENTION

These needs and others are met by embodiments of the invention, which take into account the fact that the information a monitoring and control system has is limited and which enable protocol conversion to be dynamically reconfigurable with respect to a corresponding communication protocol. This allows the monitoring and control system to be upgraded in the field as needed, with minimal effort on the part of the user. For example, the system defines and/or modifies a product profile to support new or updated products without changing a corresponding monitoring and communication tool. This also has the advantage that any changes to the underlying wireless communication protocol and infrastructure are transparent to the user. The system preferably can be used under different operating system platforms, and can accommodate different communication media and different form factors.

In accordance with one aspect of the invention, a wireless communication network comprises: a number of wireless devices; and a wireless control or monitoring device structured to wirelessly communicate with the number of wireless devices, the wireless control or monitoring device comprising: a wireless transceiver, a user output device, a user input device, and a processor cooperating with the wireless transceiver, the user output device, and the user input device, the processor comprising a routine structured to output first information from the number of wireless devices to the user output device, or to input second information from the user input device to the number of wireless devices, wherein the routine is further structured to employ an XML schema to define the first information output from the number of wireless devices to the user output device, or to define the second information input from the user input device to the number of wireless devices.

The number of wireless devices may comprise a converter between a first interface for a first communication protocol and a second interface for a second communication protocol. The first communication protocol may be a standard communication protocol, and the second communication protocol may be a different proprietary communication protocol.

The converter may be structured to communicate using the different proprietary communication protocol with a first proprietary device and a second different proprietary device; the XML schema may define a first request from the wireless control or monitoring device to the first proprietary device and a second different request from the wireless control or monitoring device to the second different proprietary device; and the converter may convert the first request to a corresponding first command to the first proprietary device, and may convert the second different request to a corresponding plurality of second different commands to the second different proprietary device.

The first request may correspond to a first expression corresponding to the first proprietary device; the second different request may correspond to a second different expression corresponding to the second different proprietary device; the first request and the second different request may both correspond to the same user command of a plurality of different user commands from the user input device; the corresponding first command may be one of a plurality of different commands accepted by the first proprietary device; and the corresponding plurality of second different commands may be some of a plurality of different commands accepted by the second proprietary device.

The wireless control or monitoring device may be further structured to commission the number of wireless devices into the wireless communication network.

The routine may be a JAVA application including a plurality of endpoints; the number of wireless devices may be a plurality of wireless devices, each of the plurality of wireless devices corresponding to a first endpoint and a second endpoint of the plurality of endpoints, the first endpoint being a discovery endpoint including first commands for network discovery and device identification, the second endpoint including second commands for the first information.

As another aspect of the invention, a portable wireless control or monitoring device is structured to wirelessly communicate with a number of wireless devices. The wireless control or monitoring device comprises: a wireless transceiver; a user output device; a user input device; and a processor cooperating with the wireless transceiver, the user output device, and the user input device, the processor comprising a routine structured to output first information from the number of wireless devices to the user output device, or to input second information from the user input device to the number of wireless devices, wherein the routine is further structured to employ an XML schema to define the first information output from the number of wireless devices to the user output device, or to define the second information input from the user input device to the number of wireless devices.

### BRIEF DESCRIPTION OF THE DRAWINGS

A full understanding of the invention can be gained from the following description of the preferred embodiments when read in conjunction with the accompanying drawings in which:

FIG. 1 is a block diagram of a wireless trip unit communication board of a wireless trip unit in accordance with an embodiment of the invention.

FIG. 2 is a block diagram of a stand-alone conversion module, which converts INCOM protocol to/from IEEE 802.15.4 wireless communications in accordance with an embodiment of the invention.

FIG. 3 is a block diagram of a dual purpose conversion module in accordance with an embodiment of the invention.

FIG. 4 is a block diagram of a system including various devices in a wireless network in accordance with an embodiment of the invention.

FIG. 5 is a block diagram including endpoints in an application for the wireless network of FIG. 4.

FIG. 6 is a block diagram of a ZigBee™ stack.

FIG. 7 is a block diagram of software in the PDA of FIG. 4.

### DESCRIPTION OF THE PREFERRED EMBODIMENTS

As employed herein, the term “number” shall mean one or an integer greater than one (i.e., a plurality).

As employed herein, the term “processor” means a programmable analog and/or digital device that can store, retrieve, and process data; a computer; a workstation; a personal computer; a microprocessor; a microcontroller; a microcomputer; a central processing unit; a mainframe computer; a mini-computer; a server; a networked processor; or any suitable processing device or apparatus.

As employed herein, EZMApp refers to a ZigBee™ Monitoring Application, which is a JAVA application for display of wireless sensor and/or INCOM data on a personal digital assistant (PDA).

As employed herein, INCOM is the INdustrial COMmunications network for data retrieval from, for example and without limitation, power system meters, relays and trip units.

As employed herein, I4 is an INCOM to 802.15.4 conversion module.

As employed herein, SDIO is Secure Digital Input Output. For example and without limitation, devices that support SDIO (e.g., without limitation, PDAs like the Palm® Treo™; laptops; cell phones) can use relatively small devices designed for the SD form factor, like GPS receivers, Wi-Fi or Bluetooth™ adapters, modems, Ethernet adapters, barcode readers, IrDA adapters, FM radio tuners, TV tuners, RFID readers, digital cameras, or other mass storage media such as hard drives.

As employed herein, P4 is a Palm® Treo™ to 802.15.4 SDIO card.

As employed herein, UML is Unified Modeling Language, which is an Object Management Group (OMG) standard for modeling software. For example and without limitation, UML can be used to model the disclosed wireless communication network 46.

As employed herein, Wireless Sensor Network (WSN) is a wireless communication network that enables smart communication of sensor/actuator devices.

As employed herein, XML is Extensible Markup Language, which is a general-purpose specification for creating custom markup languages. For example, XML is an extensible language because it allows its users to define their own elements, and facilitates the sharing of structured data across different information systems. XML can be employed to serialize data and can provide a structured format that humans and processors can understand.

As employed herein, an XML schema is a description of a type of XML document, typically expressed in terms of constraints on the structure and content of documents of that type, above and beyond the basic syntax constraints imposed by XML itself. An XML schema provides a view of the document type at a relatively high level of abstraction. Non-limiting examples of XML schema are shown in Tables 1A-1B, 2A-2B and 3A-3B, below. An XML schema can include a plurality of XML strings.

TABLE 1A

| | GET/SET | | | | |
|---|---|---|---|---|---|
| Parameter | kvp msg | Palm to P4 Query | P4 to Palm Response | P4 to I4 | Sensor to P4 |
| Notification | | | <notify> | | <notify> |
| Temperature Data | | | <type>temperature</type> | | <type>temperature</type> |
| | | | <id>iiii</id> | | <id>iiii</id> |
| | | | <data>tt.tt</data> | | <data>tt.tt</data> |
| | | | </notify> | | </notify> |
| Humidity Data | | | <notify> | | <notify> |
| | | | <type>humidity</type> | | <type>humidity</type> |
| | | | <id>iiii</id> | | <id>iiii</id> |
| | | | <data>hh.hh</data> | | <data>hh.hh</data> |
| | | | </notify> | | </notify> |
| Device Name | GET | <req> | <res> | <req> | <res> |
| | | <type>devicename</type> | <type>devicename</type> | <type>savedenergy</type> | <type>devicename</type> |
| | | <id>iiii</id> | <id>iiii</id> | <id>iiii</id> | <id>iiii</id> |
| | | </req> | <data>aaaaaaaa; | </req> | <data>aaaaaaaa; |
| | | | ssssssssssss</data> | | ssssssssssss</data> |
| | | | </res> | | </res> |
| Current | GET | <req> | <res> | <req> | |
| Parameters | | <type>current</type> | <type>current</type> | <type>current</type> | |
| Phase A | | <id>iiii</id> | <id>iiii</id> | <id>iiii</id> | |
| Phase B | | </req> | <data>aaa.a; | </req> | |
| Phase C | | | bbb.b;ccc.c;ggg.g</data> | | |
| Ground | | | </res> | | |
| Voltage | GET | <req> | <res> | <req> | |
| Parameters | | <type>voltage</type> | <type>voltage</type> | <type>voltage</type> | |
| VAB | | <id>iiii</id> | <id>iiii</id> | <id>iiii</id> | |
| VBC | | </req> | <data>aba.b; | </req> | |
| VCA | | | bcb.c;cac.a;ana.n; | | |
| VAN | | | bnb.n; cnc.n</data> | | |
| VBN | | | </res> | | |
| VCN | | | | | |
| Device Control | | | | | |
| Commands: | | | | | |
| Reset Trip | SET | <req> | <res> | <req> | |
| | | <type>resettrip</type> | <type>resettrip</type> | <type>resettrip</type> | |
| | | <id>iiii</id> | <id>iiii</id> | <id>iiii</id> | |
| | | </req> | <data>OK/FAIL</data> | </req> | |
| | | | </res> | | |

TABLE 1B

| | GET/SET | | | | |
|---|---|---|---|---|---|
| Parameter | kvp msg | Palm to P4 Query | P4 to Palm Response | P4 to I4 | Sensor to P4 |
| Open Circuit | SET | <req> | <res> | <req> | |
| Breaker | | <type>openbrkr</type> | <type>openbrkr</type> | <type>openbrkr</type> | |
| | | <id>iiii</id> | <id>iiii</id> | <id>iiii</id> | |
| | | </req> | <data>OK/FAIL</data> | </req> | |
| | | | </res> | | |
| Close Circuit | SET | <req> | <res> | <req> | |
| Breaker | | <type>closebrkr</type> | <type>closebrkr</type> | <type>closebrkr</type> | |
| | | <id>iiii</id> | <id>iiii</id> | <id>iiii</id> | |
| | | </req> | <data>OK/FAIL</data> | </req> | |
| | | | </res> | | |
| Synchronize | SET | <req> | <res> | <req> | |
| Demand Watts | | <type>synchdemand</type> | <type> synchdemand </type> | <type>synchdemand</type> | |
| Window | | <id>iiii</id> | <id>iiii</id> | <id>iiii</id> | |
| | | </req> | <data>OK/FAIL</data> | </req> | |
| | | | </res> | | |
| Snapshot | SET | <req> | <res> | <req> | |
| Energy | | <type>snapshotenergy</type> | <type> snapshotenergy </type> | <type>snapshotenergy</type> | |
| | | <id>iiii</id> | <id>iiii</id> | <id>iiii</id> | |
| | | </req> | <data>OK/FAIL</data> | </req> | |
| | | | </res> | | |
| Capture | SET | <req> | <res> | <req> | |
| Waveform | | <type>capturewf</type> | <type> capturewf </type> | <type>capturewf</type> | |
| | | <id>iiii</id> | <id>iiii</id> | <id>iiii</id> | |
| | | </req> | <data>OK/FAIL</data> | </req> | |
| | | | </res> | | |

TABLE 2A

| | | Application | Display | Data | Devices | INCOM |
|---|---|---|---|---|---|---|
| Parameter | I4 to P4 | Data Size | Format | Logging | Supported | Command |
| Notification | | | | Yes | Temperature Sensor | |
| Temperature Data | | | | | | |
| Humidity Data | | | | Yes | Humidity Sensor | |
| Device Name | <res> | 8 bytes | string | | 1150, 520 | (3 0 F) N = |
| | <type>devicename</type> | | | | | 1000 |
| | <id>iiii</id> | | | | | |
| | <data>aaaaaaaa; ssssssssssss</data> | | | | | |
| | </res> | | | | | |
| Current Parameters | <res> | | | | PS, 1150, 520 | (3 0 5) |
| Phase A | <type>current</type> | 4 bytes | Decimal Float | | PS, 1150, 520 | |
| Phase B | <id>iiii</id> | 4 bytes | Decimal Float | | PS, 1150, 520 | |
| Phase C | <data>aaa.a;bbb.b;ccc.c;ggg.g</data> | 4 bytes | Decimal Float | | PS, 1150, 520 | |
| Ground | </res> | 4 bytes | Decimal Float | | 1150, 520 | |
| Voltage Parameters | <res> | | | | | (3 0 6) & |
| | | | | | | (3 0 7) |
| VAB | <type>voltage</type> | 4 bytes | Decimal Float | | PS, 1150 | (3 0 6) |
| VBC | <id>iiii</id> | 4 bytes | Decimal Float | | PS, 1150 | (3 0 6) |
| VCA | <data>ab.ab;bc.bc;ca.ca;an.an;bn.bn; | 4 bytes | Decimal Float | | PS, 1150 | (3 0 6) |
| VAN | cn.cn</data> | 4 bytes | Decimal Float | | PS | (3 0 7) |
| VBN | </res> | 4 bytes | Decimal Float | | PS | (3 0 7) |
| VCN | | 4 bytes | Decimal Float | | PS | (3 0 7) |
| Device Control | | | | | | |
| Commands: | | | | | | |
| Reset Trip | <res> | | N/A | | 1150, 520 | (3 D 0) (0 0 2) |
| | <type>resettrip</type> | | | | | |
| | <id>iiii</id> | | | | | |
| | <data>OK/FAIL</data> | | | | | |
| | </res> | | | | | |

TABLE 2B

| | | Application | Display | Data | Devices | INCOM |
|---|---|---|---|---|---|---|
| Parameter | I4 to P4 | Data Size | Format | Logging | Supported | Command |
| Open Circuit | <res> | | N/A | | 1150 | (3 D 0) (1 0 0) |
| Breaker | <type>openbrkr</type> | | | | | |
| | <id>iiii</id> | | | | | |
| | <data>OK/FAIL</data> | | | | | |
| | </res> | | | | | |
| Close Circuit | <res> | | N/A | | 1150 | (3 D 0) (1 0 1) |
| Breaker | <type>closebrkr</type> | | | | | |
| | <id>iiii</id> | | | | | |
| | <data>OK/FAIL</data> | | | | | |
| | </res> | | | | | |
| Synchronize | <res> | | N/A | | PS, 1150 | (3 D 0) (0 0 40H) |
| Demand Watts | <type> synchdemand </type> | | | | | |
| Window | <id>iiii</id> | | | | | |
| | <data>OK/FAIL</data> | | | | | |
| | </res> | | | | | |
| Snapshot Energy | <res> | | N/A | | PS, 1150 | (3 D 0) (0 0 80H) |
| | <type> snapshotenergy </type> | | | | | |
| | <id>iiii</id> | | | | | |
| | <data>OK/FAIL</data> | | | | | |
| | </res> | | | | | |
| Capture Waveform | <res> | | N/A | | 1150 | (3 D 0) (3 0 1) |
| | <type> capturewf </type> | | | | | |
| | <id>iiii</id> | | | | | |
| | <data>OK/FAIL</data> | | | | | |
| | </res> | | | | | |

TABLE 3A

| | | INCOM | Data | | | | | | |
|---|---|---|---|---|---|---|---|---|---|
| Parameter | INCOM Data Size | Data Type | Type | Units | Offset | Multiplier | Access | Required | Comments |
| Notification | | | | Degrees C | | | | Yes | |
| Temperature Data | | | | | | | | | |
| Humidity Data | | | | % | | | | Yes | |
| Device Name | 3 msg × 3 bytes/msg | ASCII - | string | N/A | N/A | N/A | Read | | This is a separate |
| | | 8 characters | | | | | | | command. It is similar to |
| | | | | | | | | | the discovery update |
| | | | | | | | | | command, but can be read |
| | | | | | | | | | any time. It is the only |
| | | | | | | | | | way to retrieve the device |
| | | | | | | | | | name stored in the |
| | | | | | | | | | INCOM devices. aaaaaaaa |
| | | | | | | | | | is an 8 character device |
| | | | | | | | | | name that is read from |
| | | | | | | | | | some INCOM devices and |
| | | | | | | | | | cannot be changed. |
| | | | | | | | | | ssssssssssss is the device |
| | | | | | | | | | description written using |
| | | | | | | | | | the describe command. |
| Current Parameters | 4 msg × 3 bytes/msg | | | | | | | | |
| Phase A | msg 1 | float | float | Amperes | N/A | N/A | Read | Yes | |
| Phase B | msg 2 | float | float | Amperes | N/A | N/A | Read | Yes | |
| Phase C | msg 3 | float | float | Amperes | N/A | N/A | Read | Yes | |
| Ground | msg 4 | float | float | Amperes | N/A | N/A | Read | Yes | |
| Voltage Parameters | 6 msg × 3 bytes/msg | float | | | | | | | |
| VAB | msg 1 | float | float | Volts | N/A | N/A | Read | Yes | |
| VBC | msg 2 | float | float | Volts | N/A | N/A | Read | Yes | |
| VCA | msg 3 | float | float | Volts | N/A | N/A | Read | Yes | |
| VAN | msg 1 | float | float | Volts | N/A | N/A | Read | Yes | |
| VBN | msg 2 | float | float | Volts | N/A | N/A | Read | Yes | |
| | msg 3 | | float | Volts | N/A | N/A | Read | Yes | |

TABLE 3B

| | INCOM Data | | | | | | | | |
|---|---|---|---|---|---|---|---|---|---|
| Parameter | Size | INCOM Data Type | Data Type | Units | Offset | Multiplier | Access | Required | Comments |
| Device Control | | | | | | | | | |
| Commands: | | | | | | | | | |
| Reset Trip | | ACK/NACK | ACK/NACK | | | | Write | Yes | |
| Open Circuit | | ACK/NACK | ACK/NACK | | | | Write | Yes | |
| Breaker | | | | | | | | | |
| Close Circuit | | ACK/NACK | ACK/NACK | | | | Write | Yes | |
| Breaker | | | | | | | | | |
| Synchronize | | ACK/NACK | ACK/NACK | | | | Write | Yes | |
| Demand Watts | | | | | | | | | |
| Window | | | | | | | | | |
| Snapshot Energy | | ACK/NACK | ACK/NACK | | | | Write | Yes | |
| Capture Waveform | | ACK/NACK | ACK/NACK | | | | Write | Yes | |

The disclosed ZigBee™ Monitoring Application (EZMapp) is a system that employs autonomic principles to facilitate the transition of traditional industrial environments to a robust and pervasive industrial network.

The invention is described in association with an INCOM proprietary communication protocol and an IEEE 802.15.4 standard communication protocol, although the invention is applicable to a wide range of different communication protocols.

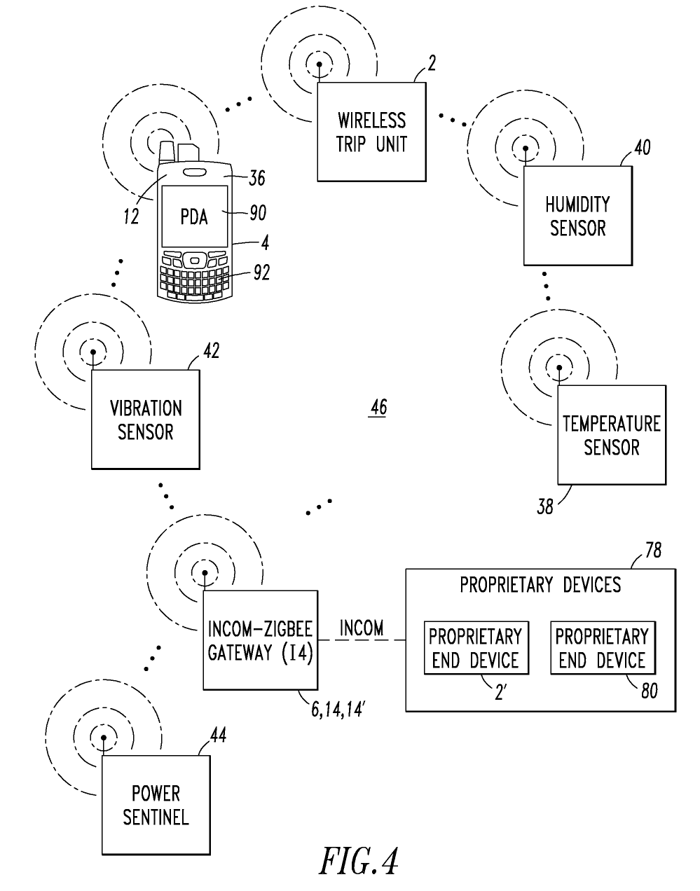

Referring to FIGS. 1 and 4, an example wireless trip unit (WTU) 2 provides wireless communication of system information from the WTU 2 to a wireless control or monitoring device, such as the example personal digital assistant (PDA), such as the example Palm® Treo™4. A wireless communication module 6 is included in an otherwise conventional trip unit, replacing a conventional wired communication circuit (not shown).

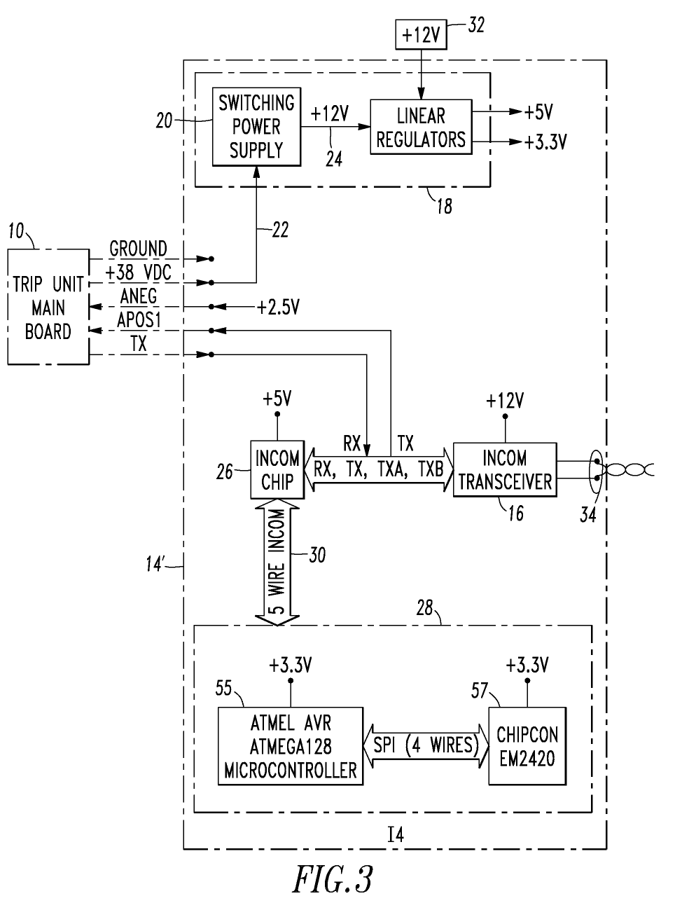

The example wireless communication module 6 is an INCOM to 802.15.4 wireless communication board, which provides some of the functions of the I4 module 14′ of FIG. 3. The module 6 permits 802.15.4 wireless communication to the example trip unit main circuit board 10. A wired connection (e.g., without limitation, electrically conductive pins (not shown)) 8 is employed from the module 6 to the example trip unit main circuit board 10 (e.g., without limitation, using electrically conductive sockets (not shown) that receive the plug-in pins). The module 6 communicates with the example Palm® Treo™4, which uses an 802.15.4 wireless SDIO card (P4) 12 (FIG. 4).

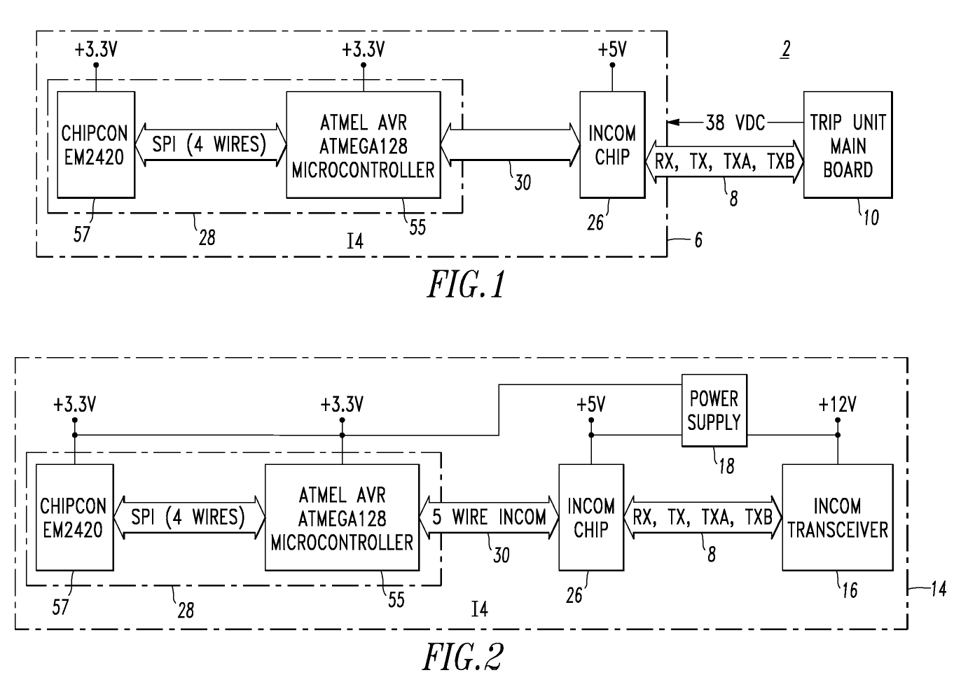

FIG. 2 shows a stand-alone I4 module 14, which includes an INCOM transceiver 16 and a power supply 18.

FIG. 3 shows a dual purpose I4 module 14′, which can either be plugged into a trip unit, in order to make it a wireless trip unit without any extra wires, or it can act as a stand-alone module with a suitable power (e.g., without limitation, a +12 V input) and an example INCOM connection, in order to convert a single INCOM device to communicate by wireless communication.

When the I4 module 14′ is installed in a wireless trip unit (not shown, but an INCOM device, such as the trip unit main circuit board 10 is shown in phantom line drawing), a switching regulator 20 converts a +38 VDC control voltage 22 (e.g., without limitation, an internal voltage generated in the trip unit to power peripherals) to +12 V 24. The INCOM transceiver 16 is not employed in this particular configuration, but may be employed if the I4 module 14′ cannot be installed within an INCOM device (not shown). An INCOM integrated circuit 26 communicates directly to a suitable processor radio (e.g., without limitation, a COTS microprocessor and a radio chip) 28 using +5 V INCOM signals 30 of an example 5-wire internal INCOM interface. An external +12 V power supply 32 may alternatively power the I4 module 14′. Hence, the I4 module 14′ can either be powered from the +38 VDC control voltage 22 or the external +12 V power supply 32. An INCOM connector 34 is used to connect to an external INCOM device (not shown) through the example twisted-pair two-wire INCOM field bus (not numbered).

Referring to FIG. 4, the wireless trip unit 2 communicates with the example Palm® Treo™4 using the 802.15.4 wireless SDIO card (P4) 12. The example Palm® Treo™4 runs an EZMApp JAVA application 36. The Palm® Treo™4 is the example commissioning and display device for a network of wireless devices (e.g., without limitation, wireless trip unit(s) 2; wireless temperature sensor(s) 38; wireless humidity sensor(s) 40; wireless vibration sensor(s) 42; wireless power sentinel(s) 44). These are examples of possible devices in a wireless communication network (e.g., a wireless sensor network (WSN), such as the example EZMApp wireless network 46). Multiple devices of the same type can exist in the network 46. Each device in the network 46 is assigned a unique IEEE address at manufacturing time.

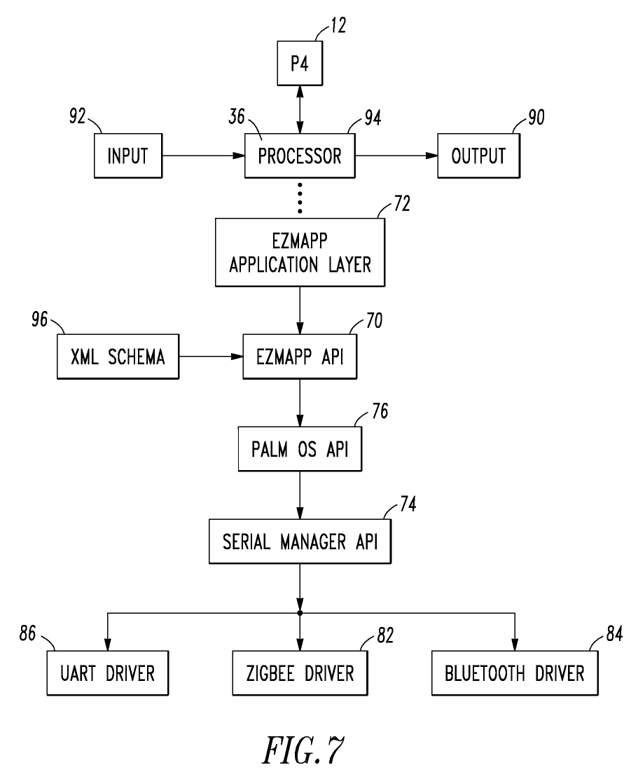

The ZigBee™ wireless networking protocol stack model of FIG. 6 includes an application layer 48, an application support layer 50, a network layer 52, a MAC sub-layer 54, and a physical layer 56. ZigBee™ profiles are an agreement on a series of messages defining an application space, for example, for “lighting control”. Endpoints are a logical extension added to a single ZigBee™ radio, such as 57 of FIG. 3, to permit support for multiple applications.

The example INCOM integrated circuit 26 is an INCOM encoder/decoder for the example INCOM proprietary communication protocol. An example IEEE 802.15.4 encoder/decoder 57 is for the standard IEEE 802.15.4 communication protocol. A processor 55 is structured to exchange information between the INCOM encoder/decoder 26 and the IEEE 802.15.4 encoder/decoder 57.

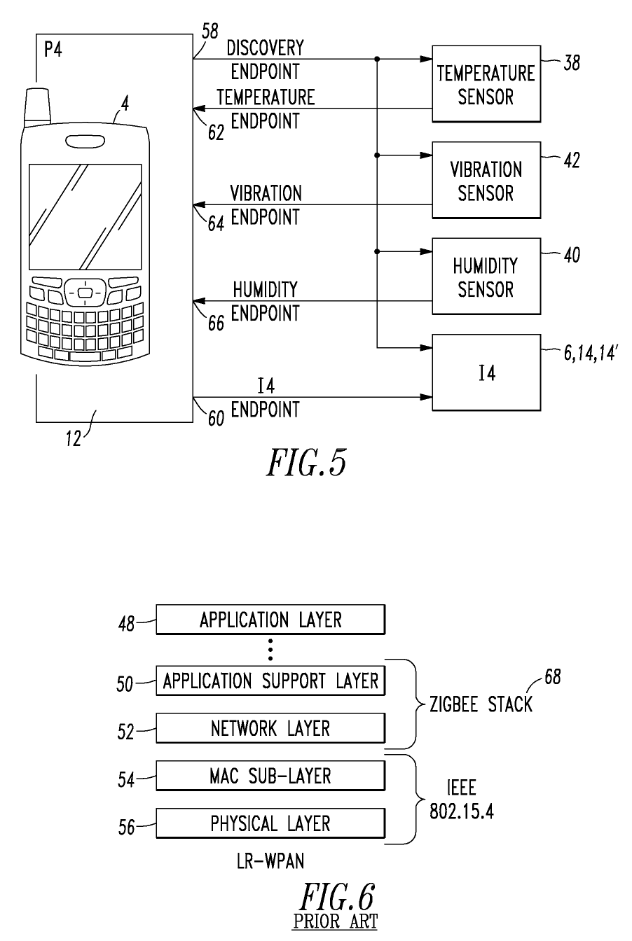

As shown in FIG. 5, each device 38,42,40,6,14,14′ in the EZMApp network 46 (FIG. 4) has a Discovery Endpoint, such as 58, with commands for network discovery and device identification. In addition, the I4 endpoint 60 and P4 endpoints 62,64,66 have commands for sharing device information (e.g., device status; currents; voltages; power; energy). For example, each of these two commands may be a cluster, which is a container for one or more attributes in a command structure that employs attributes or is synonymous with a message in a command structure that does not employ attributes. As a further example, a ZigBee™ Device Profile defines commands and responses. These are contained in clusters with the cluster identifiers enumerated for each command and response. Each ZigBee™ Device Profile message is then defined as a cluster. Alternatively, an application profile may create sub-types within the cluster known as attributes. In this case, the cluster is a collection of attributes specified to accompany a specific cluster identifier (sub-type messages).

All example devices in the example wireless sensor network (WSN) 46 of FIG. 4 preferably use the ZigBee™ stack 68 of FIG. 6. ZigBee™ is a communication protocol specification for relatively low power radios based on the 802.15.4 standard for wireless personal area networks (WPANs). ZigBee™ features include an ad-hoc self-forming network, device and service discovery, support of public and private profiles in the same network, security with AES-128 authentication and encryption at all stack levels.

An XML schema supports data exchange among the various wireless devices 4,2,38,40,42,44,6,14,14′ of FIG. 4. An example of the XML schema is contained in Tables 1A-1B, 2A-2B and 3A-3B, above. An example of the XML data exchange includes a request from the Palm® Treo™4 to the wireless trip unit 2 to send currents, as shown, where iiii is the device ID of the wireless trip unit 2:

<req>
<type>current</type>
<id>iiii</id>
</req>

The wireless trip 2 unit XML response is shown below. The wireless trip unit 2 device ID is iiii and the currents are reported as data aaaa=Ia, bbbb=Ib, cccc=Ic, and gggg=Ig:

<res>
<type>current</type>
<id>iiii</id>
<data>aaaa;bbbb;cccc;gggg</data>
</res>

The XML schema defines and/or modifies a product profile to support new or updated products (e.g., by not otherwise changing the PDA's hardware and software).

Referring to FIG. 7, the underlying wireless communication protocol and infrastructure are transparent to the user since an EZMApp API 70 isolates the application 72 from the underlying protocol. For example, on the example Palm® Treo™4 (FIG. 4), a conventional serial manager 74 is part of the Palm® operating system (OS) 76. Alternatively, any suitable OS (not shown) may be employed.

The interaction between the WSN 46 (FIG. 4) and existing industrial devices, such as 4,2,38,40,42,44,6,14,14′, necessarily leads to the task of performing a protocol conversion at some point of the process, which by itself has to be described in a reconfigurable way. To support dynamic reconfiguration of a command set of I4 type devices in the WSN 46, there are three parts: (1) isolating relevant dialog information on both the P4 side (PDA side) and INCOM side (INCOM device side) of the device 6,14,14′; (2) organizing and representing the dialog information in a form that can be transmitted to the system (i.e., a form that can be “entered” into the system); and (3) organizing and representing the dialog information in memory of the module 6,14,14′ (not shown).

The following describes the functions of the module 6,14,14′ that are a result of it being a reconfigurable protocol converter and the reconfigurable “component” of the module. This describes the dynamically reconfigurable protocol converter for INCOM devices, such as 2′ and 80 of FIG. 4, acting as end devices in the WSN 46.

There is the desire to monitor a set of proprietary devices 78, such as 2′ and 80 of FIG. 4, whose primary mode of communication is a proprietary protocol, P (e.g. without limitation, INCOM), over an open format, O (e.g., without limitation, IEEE 802.15.4). A protocol converter, such as module 6,14,14′, translates commands from the protocol P. Table 4, below, shows various ways to translate between two arbitrary protocols. This focuses on the protocol conversion necessary for monitoring and control systems.

TABLE 4

| O | P |
|---|---|
| open_command_1 | proprietary_command_1 |
| open_command_2 | proprietary_command_2 |
| | proprietary_command_3 |
| | . |
| | . |
| | . |
| open_command_3 | |
| open_command_4 | proprietary_command_4 |
| open_command_5 | |
| . | |
| . | |
| . | |
| | proprietary_command_5 |

Of these cases, only the first two are applicable to wireless monitoring and control applications, since all communications performed in the proprietary protocol, P, are performed in response to a user input command.

There is an intermediate module, such as I4 stand-alone module 14 (FIG. 2), between the monitoring and control device, such as the PDA 4, and the proprietary end device, such as 2′,80 of FIG. 4. The module 14 acts as a gateway to the WSN 46 from any arbitrary proprietary end device, such as 2′,80. That is, the intermediate module 14 is not customized to any specific end device. As mentioned, the end devices 2′,80 communicate using some proprietary device protocol (e.g., without limitation, INCOM) and, as such, different devices often use a different variant of the protocol. The I4 stand-alone module 14 talks to a subnetwork of proprietary INCOM devices, such as 2′,80. It will be appreciated that other intermediate modules, similar to the I4, could be created to convert other protocols to wireless.

The intermediate module 14 communicates with an arbitrary end device, and understands dialogs of interest in an arbitrary end device. For clarity, this is described using set notation in Equations 1 and 2:

∀dεD,S_{d}⊂M_{I} (Eq. 1)

∃i,jεD|(Sᵢ∪Sⱼ)−(Sᵢ∩Sⱼ)≠0 (Eq. 2)

wherein:
D is a number of end devices to be monitored or controlled;
d is the current end device of interest of the end devices D;
S_{d} is a number of dialogs to be monitored for dεD;
M_{I} is a number of dialogs understood by the intermediate module; and
i,j are integers.

Equation 1 defines that the set of commands known by the intermediate module 6,14,14′ is a superset of the set of interesting commands that belong to any one end device to which the intermediate module could be connected. Equation 2 provides that different proprietary end devices may have disjoint sets of commands that need to be supported.

Equation 3, below, defines a map, φ_{d}, to represent the protocol conversion component of the module 6,14,14′.

φ_{d}:M_{U}→S_{d} where dεD (Eq. 3)

wherein:
M_{U} is a number of dialogs understood by the user input device.

Equation 4 defines what is excluded from the map, φ.

$$φ : {M}_{U} -> \begin{matrix}⋃ {S}_{i} \\ i ∈ D\end{matrix} \qquad ( Eq . 4 )$$

Using set and map notation, it is clear to see that in order to support a dynamically updateable command set in the monitoring and control device 4, a map, φ_{d}, is implemented such that it is reconfigurable at application run-time for any device d. Equation 4 describes a map with a range that is the superset of all possible devices. The main problem with implementing this map occurs if there exists a user command, c, such that φ(c) exists, but it is not a valid command for d, the current device. There is no graceful method of rejecting such a user command without defining a separate map for each end device, φd. The range of the map φ_{dεD} instead only contains commands corresponding to the specific end device that the device 4 is currently connected with. Unsupported commands will map to a “rejection” element, in order that the intermediate module 6,14,14′ can reject any commands that are unsupported by the current end device, d. This also attenuates the size of the individual maps as the set D gets larger, thereby decreasing the time it takes to calculate the mapping. Furthermore, this implies that there is a procedure that selects or builds the map after the device, d, has been identified.

To implement the map described by Equation 3, the set M_{U} (the domain of φd, which is the same for all d) and the set S_{d} (the range of φ_{d}, which is dependant on d) are isolated. Note that these sets contain the dialog information of the monitoring and control device 4 and the end device 2′,80 of FIG. 4 (i.e., they correspond with the dialog information in O and P described in Table 4, above, respectively). On the monitoring and control side, to isolate this information, the largest atomic set of information that is received by the intermediate module 6,14,14′ from the monitoring and control device 4 is considered. This corresponds to a user input command in the form of protocol O. User input commands in the I4/P4 system are XML strings that are produced due to user actions and are received by the module 6,14,14′. An example listing is in Table 5 for the P4 “status” command.

TABLE 5

| XML String Item No. | XML |
|---|---|
| 1 | <req> |
| 2 | <type>status</type> |
| 3 | <id>iiii</id> |
| 4 | </req> |

Each user input corresponds to one such XML string. Hence, the set of XML strings corresponding to user inputs is the set of atomic dialogs that corresponds to M_{U}. In monitoring and control systems, it generally seems to be the case that the user inputs directly correspond with atomic dialogs in the open protocol, O.

On the proprietary end device side, the set of atomic dialogs is less apparent, but is still necessary to identify. With proprietary protocols, the same commands often act differently in different contexts. For example, in the INCOM protocol, the amount and content of the data returned by an INCOM 30F command varies based on a parameter which is given to the INCOM device as a separate message after the command. Furthermore, since the proprietary devices, d, are often not designed with a monitoring and control system in mind, the same command in O will correspond with different commands in P based on d. An example of this with P being the INCOM protocol in the I4/P4 monitoring and control system is the user request for voltage. If the module 6,14,14′ is connected to a trip unit, such as 2′, then a voltage in O corresponds to the INCOM command 306 in P. However, if the module 6,14,14′ is connected to a power monitoring device, such as 80, then the request in O corresponds to two INCOM commands, 306 and 307, in P. Therefore, it is not enough to suppose that the individual commands in P correspond to dialogs with respect to the intermediate module 6,14,14′. The extra information about the context of the command must also be included.

Here, a set of proprietary commands in P is employed that correspond to a user request directed at a specific device as the atomic dialog. This includes the INCOM commands in P, any parameters to those INCOM commands, the number and type of INCOM responses to expect from the end device 2′,80, and ordering information. The set of these dialogs that is supported by a specific end device, d, is the set S_{d}, as was defined above.

Finally, there is information that belongs to both the domain and range of φ_{d}. This information is essentially the “transition” from the domain to the range or vice versa. Information is included that describes how the map translates data or parameters received on one end to the other. An example of this in the I4/P4 system is the “status” command. The XML response to this INCOM command is described in Table 6 for the I4 “status” response.

TABLE 6

| XML String Item No. | XML |
|---|---|
| 1 | <res> |
| 2 | <type>status</type> |
| 3 | <id>iiii</id> |
| 4 | <data>aa;bb;cc;dd;ee;ff;gg</data> |
| 5 | </res> |

The “status” command corresponds to a 300 command in INCOM, with a 3-byte response. The text in the data field is the data received in the three bytes formatted into the fields aa through gg. The data is expected in this format by the monitoring and control system, so the information to format the data in this fashion is included in the dialog information.

As a non-limiting example, the INCOM Device Status is a bit-mapped response containing the following information: (1) aa=Supplier Division Code; (2) bb=Product ID; (3) cc=Comm. Version; (4) dd=Product State; (5) ee=Remote Open; (6) ff=Powered On; and (7) gg=a Product Defined Status.

With the dialog information having been isolated, the following describes the procedure to organize and represent it in a form that allows inputting the data into the monitoring and control system. Essentially, the expression φ_{d}(C)=s is organized and represented for some user command, cεM_{U}, and its corresponding dialogs in protocol P, sεS_{d}, with respect to the end device, d.

The following describes an example format for the organization of the dialog information and the procedure to specifically identify the organization (schema) for an arbitrary system. XML is employed to represent the dialog information discussed above. XML is advantageously employed because it is an open format, is a content based tagging system, and is “human-readable”. These properties are advantageous for the application of providing information to support dynamic reconfiguration to a monitoring and control system. XML is an open format, so it enjoys industry support and, thus, many XML tools are available. Tools exist to aid in the design of the schema that contains the dialog information and technologies, such as XSLT (Extensible Stylesheet Language Transformations is an XML-based language used for the transformation of XML documents into other XML or “human-readable” documents), can be utilized to auto-generate dialog schema from generic documents. Because XML is an open format, the number and quality of these tools will increase with time, as will the technologies associated with XML.

Since XML is content based, applications that use it to store information lend themselves naturally to modular design in terms of upgrading that information. The application searches for the tags of interest to it, and simply ignores tags that are not of interest. This makes it possible to update the dialog information and its organization for new monitoring and control systems and intermediate modules, while ensuring backwards compatibility for older monitoring and control systems and intermediate modules. This creates a continuity between the dynamic reconfiguration processes for different generations of the same monitoring and control system. Therefore, the maintenance process is the same across all systems using the schema.

Finally, XML is human readable. This facilitates the creation of a schema that is not difficult to understand or re-create by a non-specialist. Since it is easy to learn the schema, users can create their own custom dialogs for different devices, commands, or combinations of commands. This alleviates the burden on the manufacturer of the monitoring and control system to support a wide variety of commands. This sort of “opens up” the dynamic reconfigurabilty of the system.

The disclosed system is usable on different operating system platforms since JAVA is portable to different operating systems.

Different communication media and different form factors are accommodated through communications using ZigBee™ driver 82, Bluetooth™ driver 84, and a serial driver 86 as shown in FIG. 7.

The example PDA 4 includes a user output device, such as the example display 90, a user input device, such as the example keyboard 92, a processor 94 cooperating with a wireless transceiver, such as the example IEEE 802.15.4 wireless SDIO card (P4) 12, the user output device 90, and the user input device 92. The processor 94 includes a routine, such as the example EZMApp JAVA application 36 (FIG. 4), which is structured to output first information (e.g., without limitation, status) from the wireless devices 2,38,40,42,44,6,14,14′ (FIG. 4) to the user output device 90, or to input second information (e.g., without limitation, commands) from the user input device 92 to such wireless devices. The routine 36 is further structured to employ an XML schema 96 (e.g., without limitation, as shown, for example, by some or all of the Appendix; Table 2; Table 3; a plurality of XML strings) to define the first information output from the wireless devices 2,38,40,42,44,6,14,14′ to the user output device 90, or to define the second information input from the user input device 92 to such wireless devices. The example PDA 4 preferably includes a commissioning routine 98 to commission the wireless devices into the wireless communication network 46.

Non-limiting examples of the various devices 2,2′,38,40,42,44,78,80 include a wireless temperature sensor 38, a wireless humidity sensor 40, a wireless trip unit 2, a wireless vibration sensor 42, a wireless power sentinel 44, an INCOM to IEEE 802.15.4 adapter 6,14,14′, a wireless current sensor (not shown), a wireless meter (not shown), a wireless I/O module (not shown), a wireless indicator (not shown), and a wireless audible alarm (not shown).

The cost of the disclosed system as compared to the cost of writing and testing a new software revision and the cost of releasing dynamic updates is significantly smaller. In addition, final users can now employ systems that are customized to their needs.

The disclosed system enables relatively quick reconfiguration of monitoring and control commands in systems with proprietary protocols, like the example proprietary INCOM, using ZigBee™ as the enabling service for remote monitoring and control, and XML as the language for expressing on-the-fly functionality and user interfacing of legacy industrial devices. The problem solved is the sensible reduction of a priori device information and interaction scenarios as a prerequisite to designing a robust, pervasive industrial network.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A wireless communication network comprising:
a number of wireless devices; and
a wireless control or monitoring device structured to wirelessly communicate with said number of wireless devices, said wireless control or monitoring device comprising:
a wireless transceiver,
a user output device,
a user input device, and
a processor cooperating with said wireless transceiver, said user output device, and said user input device, said processor comprising a routine structured to output first information from said number of wireless devices to said user output device, or to input second information from said user input device to said number of wireless devices,
wherein said routine is further structured to employ an XML schema to define said first information output from said number of wireless devices to said user output device, or to define said second information input from said user input device to said number of wireless devices.

2. The wireless communication network of claim 1 wherein said wireless communication network is a wireless sensor network.

3. The wireless communication network of claim 1 wherein said number of wireless devices is selected from the group consisting of a wireless sensor device, and a wireless actuator device.

4. The wireless communication network of claim 1 wherein said number of wireless devices is selected from the group consisting of a wireless trip unit, a wireless temperature sensor, a wireless humidity sensor, a wireless vibration sensor, and a wireless power sensor.

5. The wireless communication network of claim 1 wherein said number of wireless devices comprises a converter between a first interface for a first communication protocol and a second interface for a second communication protocol.

6. The wireless communication network of claim 5 wherein said first communication protocol is a standard communication protocol; and wherein said second communication protocol is a different proprietary communication protocol.

7. The wireless communication network of claim 6 wherein said standard communication protocol is IEEE 802.15.4; and wherein said different proprietary communication protocol is INCOM.

8. The wireless communication network of claim 7 wherein said converter comprises an INCOM encoder/decoder for said different proprietary communication protocol, an IEEE 802.15.4 encoder/decoder for said standard communication protocol, a processor structured to exchange information between said INCOM encoder/decoder and said IEEE 802.15.4 encoder/decoder, and a power supply structured to power said INCOM encoder/decoder, said IEEE 802.15.4 encoder/decoder and said processor.

9. The wireless communication network of claim 6 wherein said converter is structured to communicate using said different proprietary communication protocol with a first proprietary device and a second different proprietary device; wherein said XML schema defines a first request from said wireless control or monitoring device to said first proprietary device and a second different request from said wireless control or monitoring device to said second different proprietary device; and wherein said converter converts said first request to a corresponding first command to said first proprietary device, and converts said second different request to a corresponding plurality of second different commands to said second different proprietary device.

10. The wireless communication network of claim 9 wherein said first proprietary device is an INCOM trip unit and said corresponding first command is an INCOM command to request a number of sensed parameters of said INCOM trip unit; and wherein said second different proprietary device is an INCOM power monitoring device and said corresponding plurality of second different commands are two different INCOM commands to request a number of sensed parameters of said INCOM power monitoring device.

11. The wireless communication network of claim 9 wherein said first request corresponds to a first expression corresponding to said first proprietary device; wherein said second different request corresponds to a second different expression corresponding to said second different proprietary device; wherein said first request and said second different request both correspond to the same user command of a plurality of different user commands from said user input device; wherein said corresponding first command is one of a plurality of different commands accepted by said first proprietary device; and wherein said corresponding plurality of second different commands are some of a plurality of different commands accepted by said second proprietary device.

12. The wireless communication network of claim 1 wherein said wireless control or monitoring device is further structured to commission said number of wireless devices into said wireless communication network.

13. The wireless communication network of claim 1 wherein said wireless control or monitoring device is a personal digital assistant.

14. The wireless communication network of claim 1 wherein said wireless transceiver is a wireless Secure Digital Input Output module.

15. The wireless communication network of claim 1 wherein said routine is a JAVA application including a plurality of endpoints; wherein said number of wireless devices are a plurality of wireless devices, each of said plurality of wireless devices corresponding to a first endpoint and a second endpoint of said plurality of endpoints, said first endpoint being a discovery endpoint including first commands for network discovery and device identification, said second endpoint including second commands for said first information.

16. The wireless communication network of claim 15 wherein said first information is selected from the group consisting of device status, current, voltage, power, and energy.

17. The wireless communication network of claim 1 wherein said XML schema defines a request from said wireless control or monitoring device to said number of wireless devices for said first information.

18. The wireless communication network of claim 17 wherein said number of wireless devices is a wireless trip unit; and wherein said first information is a number of currents.

19. The wireless communication network of claim 18 wherein said request comprises:
<req>,
<type>current</type>,
<id>iiii</id>, and
</req>,
wherein said iiii is a device identifier of said wireless trip unit.

20. The wireless communication network of claim 1 wherein said XML schema defines a response from said number of wireless devices to said user input device including said second information.

21. The wireless communication network of claim 20 wherein said number of wireless devices is a wireless trip unit; and wherein said second information is a plurality of currents.

22. The wireless communication network of claim 21 wherein said response comprises:
<res>,
<type>current</type>,
<id>iiii</id>,
<data>aaaa;bbbb;cccc;gggg</data>, and
</res>,
wherein said iiii is a device identifier of said wireless trip unit, said aaaa is a current of a first phase of said wireless trip unit, said bbbb is a current of a second phase of said wireless trip unit, said cccc is a current of a third phase of said wireless trip unit, and said gggg is a ground current.

23. The wireless communication network of claim 1 wherein said wireless control or monitoring device is structured to wirelessly communicate with said number of wireless devices over a plurality of different wireless communication media.

24. The wireless communication network of claim 1 wherein said wireless control or monitoring device is reconfigurable through said XML schema.

25. A portable wireless control or monitoring device structured to wirelessly communicate with a number of wireless devices, said wireless control or monitoring device comprising:
a wireless transceiver;
a user output device;
a user input device; and
a processor cooperating with said wireless transceiver, said user output device, and said user input device, said processor comprising a routine structured to output first information from said number of wireless devices to said user output device, or to input second information from said user input device to said number of wireless devices,
wherein said routine is further structured to employ an XML schema to define said first information output from said number of wireless devices to said user output device, or to define said second information input from said user input device to said number of wireless devices.
